(19) United States
(12) Patent Application Publication
(10) Pub. No.: US 2009/0180035 A1
(43) Pub. Date: Jul. 16, 2009

(54) FILTER ARRANGEMENT FOR A TUNER IN A BROADBAND RECEIVER

(75) Inventors: Mathias Anton Muller, Line Lexington, PA (US); Michael Hauger, Philadelphia, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/972,617

(22) Filed: Jan. 10, 2008

(51) Int. Cl. H04N 5/50

(52) U.S. Cl. 348/729; 348/E05.097

(57) ABSTRACT

A receiver is provided for extracting a digitally encoded transport stream from a broadband signal containing a plurality of channels. The receiver includes an input for receiving the broadband signal and a tuner for selecting a selected channel from the broadband signal. The receiver also includes a filter arrangement having a high pass filter and a low pass filter selectively coupling the input to the tuner such that an unselected one of the filters is coupled to ground. A demodulator is provided for demodulating a digitally encoded transport stream from the selected channel.

### FIELD OF THE INVENTION

The present invention relates to a tuner for selecting a channel from a broadband radio frequency input signal containing a plurality of channels.

### BACKGROUND OF THE INVENTION

In recent years, broadband network architectures have evolved from unidirectional analog systems to bi-directional, Hybrid Fiber Coaxial (HFC) systems with a mix of analog and digital signals. Such networks may deliver analog/digital video, analog/digital audio, and high speed data to cable subscribers. The most common configuration comprises a fiber optic main distribution network associated with a local distribution network using coaxial cable. For traditional broadcast TV service, most HFC networks collect satellite and trunk cable feeds, local off-the-air television channels, and other video/audio channels and distribute them from the headend using an analog modulated signal scheme such as an amplitude modulated vestigial sideband (AM-VSB) scheme. As shown in FIG. 1, the channels are placed onto different RF sub-carriers within a frequency spectrum allocated for downstream transmission (typically 50 to 550 MHz), with each channel generally occupying 6 MHz of the spectrum. On the other hand, most new services being offered on broadband networks such as video-on-demand (VOD), digital TV, high-speed data (HSD), and IP telephony, are distributed using digital modulated RF sub-carriers. The digital modulated signals are typically multilevel quadrature amplitude modulated (M-QAM) sub-carriers within an RF band that is often between about 550-870 or, more recently, between 550 MHz and 1 Ghz. In the M-QAM scheme, both the amplitude and phase of the sub-carrier are varied to represent each digital symbol. For example, in a 256 QAM, 256 combinations of amplitude and phase are used. Finally, the M-QAM RF sub-carriers and the AM-VSB RF sub-carriers may be combined so that the resulting frequency multiplexed subcarrier signal may be used to modulate an optical carrier generated by a laser. This modulation and multiplexing scheme is sometimes referred to as a hybrid multichannel AM-VSB/M-QAM transport architecture.

Receivers used in televisions or set top terminals include a tuner for receiving the analog and digital sub-carrier frequencies or channels. The function of the tuner is to select a desired frequency and reject the remaining frequencies. The tuner also converts the radio frequency (“RF”) of the selected frequency into a standard intermediate frequency (“IF”) signal in preparation for further processing. Both single conversion tuners and dual conversion tuners can be used to perform the conversion. Dual conversion tuners generally provide higher performance, but use more components and are more expensive than single conversion tuners. Although single conversion tuners often provide lower performance than dual conversion tuners, single conversion tuners are often desirable because they generally require fewer components and are therefore less expensive. For example, a single conversion tuner uses only a single phase lock loop for providing a single local oscillator (“LO”) reference signal, as opposed to a dual conversion tuner, which requires two LOs. As another example, a single conversion tuner uses only a single IF filter and mixer for the conversion, whereas a dual conversion tuner requires two IF filters and two mixers for the conversion.

As indicated in FIG. 1, the power of the RF frequency spectrum that is received from the broadband network is often sloped in frequency. In particular, the higher frequencies are at lower power levels than the lower frequencies. In some cases the lower frequency channels can be as much as 20 dB stronger than the higher frequency channels. This sloped spectrum can greatly reduce the dynamic range of the tuner. This is particularly true when attempting to tune to a frequency that is at the high end of the spectrum where the power level is much lower than at the low end of the spectrum.

Single and dual conversion tuners are generally designed to process a narrow range of frequencies at any one time. In the case of a single conversion tuner this is often accomplished through the use of a tracking filter on the front end of the tuner. As the receiver is tuned across the frequency band during a channel change, the tracking filter is tuned to allow only a few channels to pass into the tuner. As a result, the tuner circuit has to provide good response characteristics for only a few channels at a time, instead of over substantially the entire bandwidth. For example, in a broadband network the tracking filter would allow only a few channels to enter the tuner, instead of the full 100 or more channels that are often available. The tracking filter beneficially reduces the dynamic range required in the front end of a conventional receiver.

There are several problems, however, associated with using a tracking filter in single conversion tuners. For instance, since the tracking filter generally must track the input frequency as the tuner is being tuned, it can be difficult to maintain good flatness, bandpass and signal rejection characteristics across the entire band. In addition, in some cases the tracking filter needs to be manually tuned to the appropriate frequencies when the receiver is being assembled during manufacturing.

Another technique that may be employed to process a narrow range of frequencies at any one time in both single and dual conversion tuners involves the use of a diplex filter to split the RF band into two parts. Unfortunately, this degrades performance at the frequencies or channels at the transition between the two bands because of insertion loss that is generally equal to about 3 dB or more.

### BRIEF DESCRIPTION OF THE DRAWINGS

FIG. 1 shows the frequency spectrum employed by the analog and digital channels in a broadband network.

FIG. 2 shows a high level block diagram of one example of a receiver arrangement for receiving video and other information signals transmitted over a broadband delivery system.

FIG. 3 shows one example of a filter arrangement that may be used at the input of the receiver arrangement shown in FIG. 2 to select a subset of channels from among those received from the broadband network.

FIG. 4 shows the frequency response of the filter arrangement depicted in FIG. 3 over the RF frequency spectrum of a broadband network.

FIG. 5 shows one particular circuit diagram that may be employed to implement the filter arrangement shown in FIG. 3.

FIGS. 6 and 7 show an illustrative filter response for the filter arrangement shown in FIG. 5.

FIG. 8 shows one example of a dual conversion tuner that may be employed in the receiver depicted in FIG. 2.

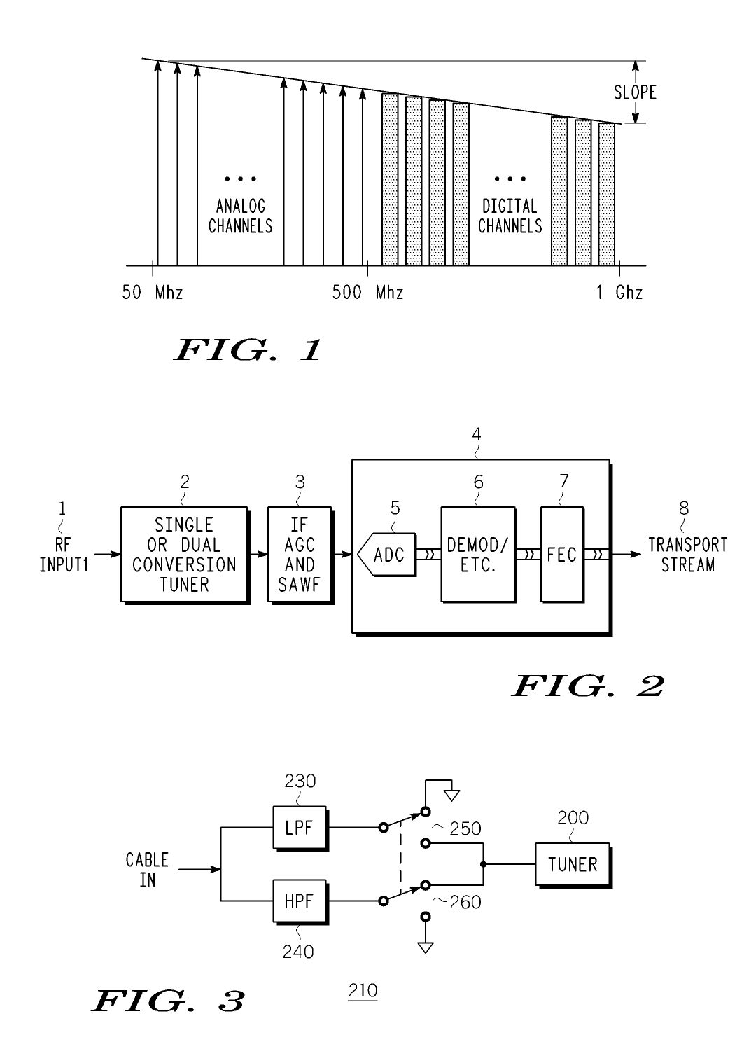

### DETAILED DESCRIPTION

FIG. 2 shows a high level block diagram of a receiver arrangement for receiving video and other information signals transmitted over a broadband delivery system. The receiver includes a radio frequency (RF) input 1 connected to a single or dual conversion tuner 2 for selecting a desired channel for reception and converting it to a non-zero intermediate frequency (IF). The output of the tuner 2 is connected to an IF stage 3, which provides variable gain in accordance with an automatic gain control (AGC) arrangement and channel filtering in the form of a surface acoustic wave filter (SAWF) for passing the selected channel at the intermediate frequency and for attenuating other channels which may be present in the output of the tuner 2.

The output of the IF stage 3 is connected to a demodulator module 4. The demodulator module 4 includes an analog/digital converter (ADC) 5, which converts the selected channel at intermediate frequency to the digital domain. The output of the converter 5 is supplied to a demodulator 6 which, in the case of coded orthogonal frequency division multiplex (COFDM) signals, principally comprises a demodulator and a fast Fourier transform (FFT) stage. The output of the demodulator 6 is supplied to a forward error correction (FEC) block 7 which performs the appropriate error correction, such as Reed Solomon or Viterbi correction. The demodulated error-corrected data is provided as a digitally encoded (e.g., MPEG) transport stream 8 at the output of the demodulator 4 for further processing by a baseband section (not shown) of the receiver.

In the case of single conversion tuner, a frequency translator converts the selected channel to a standard non-zero intermediate frequency. In the case of digital terrestrial television receivers and digital cable receivers, three intermediate frequencies are in common use: 36 MHz is used, for example, for COFDM modulation in Europe; 44 MHz is used, for example, for VSB (vestigial sideband) modulation in USA; and 57 MHz is used, for example, in Japan. In the case of a dual conversion tuner, a frequency translator commonly upconverts the selected channel to a frequency of 1200 MHz (or some other frequency greater than 1 GHZ) before down converting to a frequency of 36 or 44 MHz.

As previously mentioned, a diplex filter is sometimes used to split the RF spectrum input into two parts in order to decrease the total power into the tuner. Unfortunately, this gives rise to an insertion loss of 3 dB or more at the transition frequencies or channels. This insertion loss can be substantially reduced by using a filter arrangement of the type shown in FIG. 3.

In FIG. 3 a filter arrangement 210 is inserted between the RF input received from the broadband network and the tuner 200. The filter arrangement 210 includes a low pass filter 230 and a high pass filter 240. The low pass filter allows the low frequency channels (e.g., 50-500 MHz) received from the broadband network to pass to the tuner 200 and the high pass filter 240 allows the high frequency channels (e.g., 500 MHz to 1 GHz) to pass to the tuner 200. The output from the filters 230 and 240 can be individually selected using a switch arrangement, represented in FIG. 3 by switches 250 and 260. The unused filter output is shorted to ground, which advantageously serves to reflect more energy at the transition frequencies (i.e., the frequencies at which the passbands of the two filters overlap) back into the unused filter, thereby reducing the insertion loss of the filter arrangement.

In the particular implementation of the filter arrangement 210 shown in FIG. 3, the low pass and high pass filters 230 and 240 are arranged in parallel. The output from the low and high pass filters 230 and 240 are respectively connected to switches 250 and 260. When a high frequency channel is to be selected, the low pass filter 230 is shorted to ground by switch 250 so that only the output from the high pass filter 240 is received by the tuner 200. Likewise, when a low frequency channel is to be selected, the high pass filter 240 is shorted to ground by switch 260 so that only the output from the low pass filter 230 is received by the tuner 200 via switch 250.

Switches 250 and 260 are typically selected to have low insertion losses so that the insertion loss savings achieved by shorting the unused filter output to ground is not offset by the insertion losses of the switches. Switches with low insertion losses are readily available and include, for example, PIN diode, CMOS and GaAs FET switches. These switches can have insertion losses as low as a few tenths of a dB. Since the savings that can be achieved by the use of a filter arrangement of the type shown in FIG. 3 relative to a conventional diplex filter is as much as 2-3 dB, the overall or net reduction in the insertion loss is quite significant.

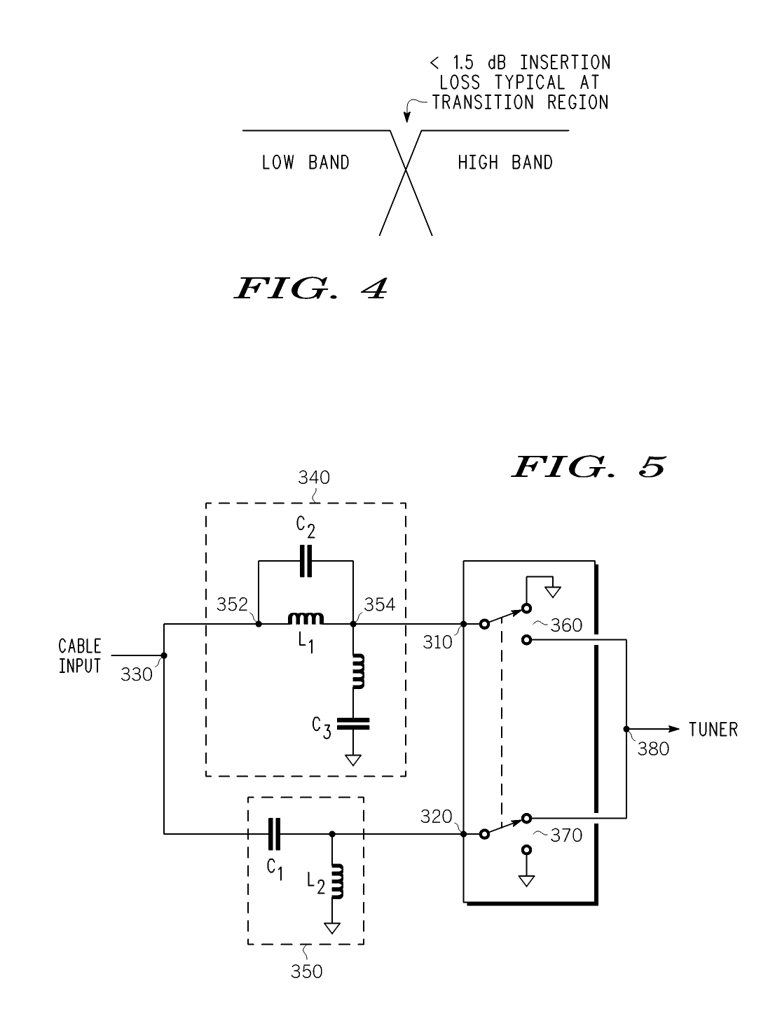

FIG. 4 shows the frequency response of the filter arrangement depicted in FIG. 3 over the RF frequency spectrum of a broadband network. At the transition frequency or frequencies between the low pass filter and the high pass filter the overall insertion can be reduced to about 1.5 dB or less.

FIG. 5 shows one particular circuit diagram that may be employed to implement the filter arrangement in FIG. 3. In this example the filter arrangement is implemented as a single pole passive filter, although in some cases multipole filters may be used as well. As shown the filter arrangement includes a low pass filter 340 having an inductor L1 and capacitors C2 and C3 and a high pass filter 350 having an inductor L2 and a capacitor C1. The low pass and high pass filters 340 and 350 are connected in parallel to an input node 330 that receives the RF frequency spectrum from the broadband network. In the low pass filter 340 the inductor L1 and the capacitor C2 are coupled in parallel between nodes 352 and 354 and a capacitor C3 is coupled in parallel between ground and node 310, which serves as an input to a first switch 360. In the high pass filter 350 the capacitor C1 is serially coupled between node 330 and node 320, which serves as an input to the second switch 370. The inductor L2 is coupled in parallel between ground and node 320. First and second switches 360 and 370 selectively switch the filters 340 and 350 between node 330 and the node 380 into the tuner, while the unselected switch is coupled to ground.

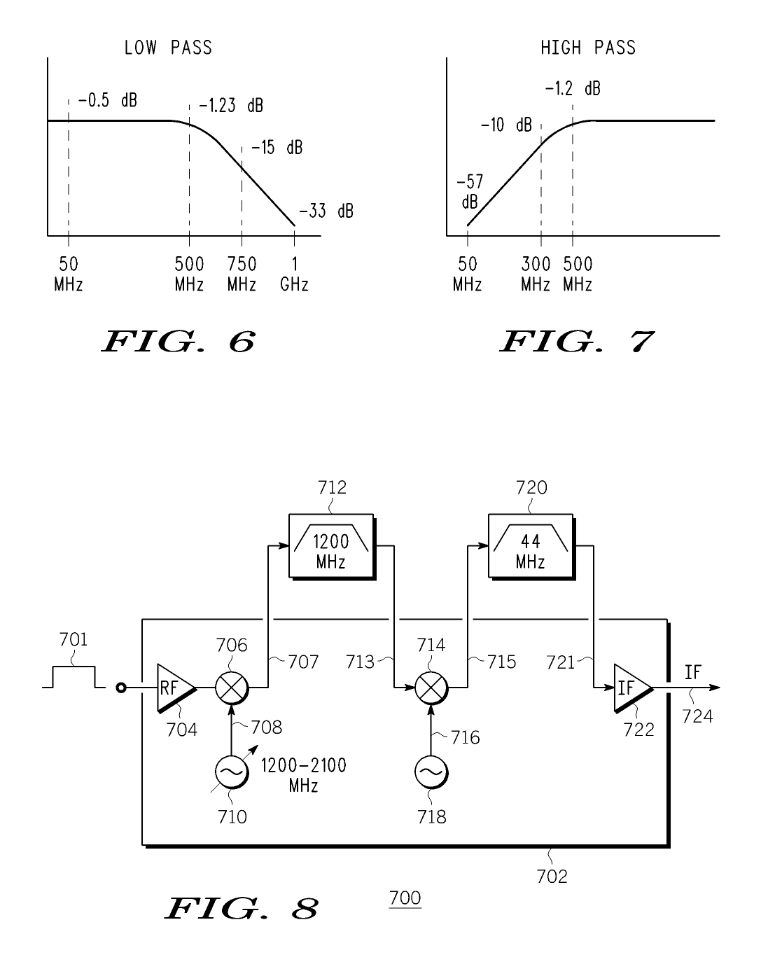

FIGS. 6 and 7 show an illustrative filter response for the low pass and high pass filters 340 and 350, respectively for the following representative values for the capacitors and inductors shown in FIG. 5: C1=5.1 pf, L2=12 nH, C2=1.5 pf, L1=17 nH, C3=2.2 pf. Of course, these values are merely illustrative and may vary depending on the particulars of the application, the details of the circuit design and the like. As indicated in FIGS. 6 and 7, the filter response is characterized by a −1.2 dB insertion loss of the passband and a −15 dB rejection or attenuation loss at a particular frequency.

FIG. 8 shows one example of a dual conversion tuner that may be employed in the receiver depicted in FIG. 2. The tuner 700 performs two frequency translations (one up-conversion, one down-conversion) to achieve a high image rejection requirement. The tuner 700 receives a RF signal 701 from the output of the filter arrangement 210 (again, no reference to 210) depicted in FIG. 3. Accordingly, the RF signal 701 includes multiple channels that collectively occupy a frequency range of about 50 MHz-500 MHz or about 500 MHz-1 GHz. The tuner 700 down-converts a selected channel from the RF signal 701 and outputs the selected channel as an IF signal 724. In some examples the frequency of the IF signal 724 is 36 MHz or 44 MHz, or some other desired IF frequency.

The detailed operation of the tuner 700 is as follows. An RF amplifier 704 amplifies the RF input signal 701 prior to frequency translation. The first frequency translation is performed by a first mixer 706 that mixes the RF input signal 701 with a variable (local oscillator) LO signal 708. The LO 710 varies the frequency of the LO signal 708 from 1200 to 2100 MHz. Therefore, the RF input signal 701 is up-converted to a frequency above the 50 MHz to 1 GHz band, resulting in an up-converted signal 707. The up-converted signal 707 is sent to a SAW filter 712, which has a narrow passband at 1200 MHz. The SAW filter 712 selects a desired channel 713 that falls within its narrow passband, and substantially rejects all of the remaining channels. Therefore, a particular channel is selected by varying the frequency of the LO signal 708 so that the desired channel is up-converted into the passband of the SAW filter 712. The desired channel 713 then undergoes a second frequency translation by sending it to a second mixer 714, which is driven by a fixed local oscillator 718. The mixer 714 down-converts the desired channel using a fixed local oscillator signal 716, resulting in an IF signal 715. Given that the SAW filter 712 is centered at 1200 MHz, the frequency of the LO signal 716 is appropriately selected to provide an IF at 36 MHz, 44 MHz, or some other desired IF frequency. The IF filter 720 further removes any unwanted harmonics and images from the IF signal 715, resulting in the IF signal 721. The IF signal 721 is amplified by the IF amplifier 722, to produce the IF output 724.

1. A tuner for selecting a channel from a broadband signal containing a plurality of channels, comprising:
an input for receiving the broadband signal;
at least one frequency translator for converting a selected channel to an intermediate frequency; and
a filter arrangement including a high pass filter and a low pass filter selectively coupling the input to the frequency translator such that an unselected one of the filters is coupled to ground.

2. The tuner of claim 1 wherein the filter arrangement further comprises: a first switch selectively coupling an output of the high pass filter to the frequency translator and to ground; and a second switch selectively coupling an output of the low pass filter to the frequency translator and to ground.

3. The tuner of claim 2 wherein the first and second switches are selected from the group consisting of a PIN diode switch, a CMOS switch and a GaAs FET switch.

4. The tuner of claim 1 wherein the broadband signal occupies a frequency band between about 50 MHz and 1 GHz.

5. The tuner of claim 1 wherein the frequency translator includes a local oscillator for generating a variable local oscillator signal and a first mixer for mixing the broadband signal with the variable local oscillator signal.

6. The tuner of claim 1 wherein the filter arrangement has an insertion loss of about 1.5 dB or less.

7. The tuner of claim 1 wherein the high pass and low pass filters are single pole passive filters.

8. The tuner of claim 1 wherein the high pass and low pass filters have a cutoff frequency of about 500 MHz.

9. The tuner of claim 1 wherein the frequency translator includes a first frequency translator for up-converting the broadband signal, a filter for selecting the selected channel from the up-converted broadband signal and a second frequency translator for down-converting the selected channel to the intermediate frequency.

10. A receiver for extracting a digitally encoded transport stream from a broadband signal containing a plurality of channels, comprising:
an input for receiving the broadband signal;
a tuner for selecting a selected channel from the broadband signal;
a filter arrangement including a high pass filter and a low pass filter selectively coupling the input to the tuner such that an unselected one of the filters is coupled to ground; and
a demodulator for demodulating a digitally encoded transport stream from the selected channel.

11. The receiver of claim 10 wherein the filter arrangement further comprises:
a first switch selectively coupling an output of the high pass filter to the frequency translator and to ground; and a second switch selectively coupling an output of the low pass filter to the frequency translator and to ground.

12. The receiver of claim 11 wherein the first and second switches are selected from the group consisting of a PIN diode switch, a CMOS switch and a GaAs FET switch.

13. The receiver of claim 10 wherein the broadband signal occupies a frequency band between about 50 MHz and 1 GHz.

14. The receiver of claim 10 wherein the tuner includes a frequency translator having a local oscillator for generating a variable local oscillator signal and a first mixer for mixing the broadband signal with the variable local oscillator signal.

15. The receiver of claim 10 wherein the filter arrangement has an insertion loss of about 1.5 dB or less.

16. The receiver of claim 10 wherein the high pass and low pass filters are single pole passive filters.

17. The receiver of claim 10 wherein the high pass and low pass filters have a cutoff frequency of about 500 MHz.

18. The receiver of claim 10 wherein the tuner includes a frequency translator having a first frequency translator for up-converting the broadband signal, a filter for selecting the selected channel from the up-converted broadband signal and a second frequency translator for down-converting the selected channel to the intermediate frequency.
